(19) United States
(12) Patent Application Publication
(10) Pub. No.: US 2009/0018215 A1
(43) Pub. Date: Jan. 15, 2009

(54) Fumigant for wood parasitic nematodes and wood fumigation method

(75) Inventors: Yutaka Abe, Kanagawa (JP); Yoshio Hisada, Kanagawa (JP); Toru Itabashi, Saitama (JP); Hiroyuki Miyaji, Saitama (JP); Yukihiro Soma, Kanagawa (JP); Yasuo Matsumoto, Tokyo (JP); Hitoshi Komatsu, Tokyo (JP)

Correspondence Address: SUGHRUE MION, PLLC, 2100 PENNSYLVANIA AVENUE, N.W., SUITE 800, WASHINGTON, DC, 20037, US

(73) Assignees: Yashima Sangyo Co., LTD., Kawasaki-shi (JP); Japan Fumigation Technology Association, Tokyo (JP); Arysta Life Science Corporation, Tokyo (JP)

(21) Appl. No.: 11/662,404

(22) PCT Filed: Sep. 9, 2005
(86) PCT No.: PCT/JP2005/017087

§ 371 Date: Jul. 15, 2008

(30) Foreign Application Priority Data
Sep. 10, 2004 (JP) 2004-264089

(51) Int. Cl. A01N 29/00; A01P 5/00

(52) U.S. Cl. 514/743

(57) ABSTRACT

The present invention provides a fumigant for wood parasitic nematodes comprising methyl iodide dissolved in liquefied carbon dioxide, in place of methyl bromide the use of which is globally regulated as ozone depleting substance or a fumigant using methyl iodide dissolved in liquefied carbon dioxide in combination with one or more compounds selected from the group consisting of sulfuryl fluoride, methyl isothiocyanate, phosphine, ethylene oxide, carbonyl sulfide and propylene oxide, and a fumigation method for killing wood parasitic nematodes by using said fumigant.

### TECHNICAL FIELD

The present invention relates to a fumigant for wood parasitic nematodes. More specifically, the present invention relates to a fumigant for wood parasitic nematodes prepared by dissolving methyl iodide (CH₃I) in liquefied carbon dioxide and wood fumigation method.

### BACKGROUND ART

All agricultural and forest products imported to Japan are quarantined in view of plant protection and it is obligatory to remove harmful pests and pathogens through fumigation or the like appropriately, to prevent harmful plants and animals which are not original inhabitants of Japan from entering into Japan and proliferating in Japan. Also, in terms of wood materials imported to Japan, disinfection is conducted according to standards of disinfection method shown in quarantine guidelines for imported wood materials, for the same purpose as above. As methods for treating imported woods already put to practical use, a method using chemicals such as methyl bromide, a physical method immersing materials in water and a method using these techniques in combination are available. Among these, the most frequently employed method is the fumigation method using methyl bromide. Since this method is simple and its effect is definite, it is widely used. However, methyl bromide is one of causative substances for ozone layer depletion and recently, movement toward regulating use of methyl bromide is accelerated from the viewpoint of protection of the global environment.

Wooden packaging materials are in heavy usage in import and export freight and most of them are made of non-treated green lumber. Therefore, harmful animals and plants, attached to or parasitic on wood packaging materials, may enter importing or exporting countries.

In 2001, China announced emergency measures for quarantine of packing materials using conifer lumber with respect to cargoes imported from the United States and Japan. It required thermal treatment and was aimed at prevention of entrance of Bursaphelenchus xylophilus, which causes death of pine trees. Later from then, Brazil, Russia, Finland and EC member countries also adopt such quarantine measures. In 2002, the Interim Commission on Phytosanitary Measures adopted “Guidelines For Regulating Wood Packaging Material In International Trade” at FAO and movement toward employing the guidelines as international standards for phytosanitary measures are spreading in major countries.

The “Guidelines For Regulating Wood Packaging Material In International Trade” describe as approved measures regarding wood packaging materials (1) heat treatment (for 30 minutes at 56° C. in the core part of the material), (2) kiln dry, (3) pressure impregnation of antiseptic agent and (4) fumigation with methyl bromide.

Under these circumstances, as fumigants replacing methyl bromide, methyl isothiocyanate (Japanese Patent No. 2887746), a fumigant containing methyl isothiocyanate and sulfuryl fluoride as active ingredients (Japanese Patent Application Laid-Open No. 2001-31501) and a fumigant containing methyl iodide as active ingredient (Japanese Patent Application Laid-Open No. 2003-136506) have been proposed. However, all of these fumigants are intended for extermination of harmful insects in timber and neither fumigant nor fumigation method relating to phytosanitary measures for extermination of wood parasitic nematodes such as Bursaphelenchus xylophilu is known.

### DISCLOSURE OF INVENTION

Among the approved measures relating to wood packaging materials, since heat treatment, kiln dry, pressure impregnation of antiseptic agent and the like all require facilities and places for conducting disinfection are limited, these methods cannot be conducted conveniently. On the other hand, although fumigation with methyl bromide is relatively inexpensive and simple disinfection method, use of methyl bromide as causative substance for ozone layer depletion is globally regulated.

Therefore, the object of the present invention is to provide a novel fumigant for wood parasitic nematodes replacing methyl bromide and wood fumigation method.

The present inventors made intensive studies on fumigant replacing methyl bromide, which enables simple and inexpensive disinfection of wood workable anywhere. Although methyl iodide exhibits excellent insecticidal effect on nematodes as methyl bromide does, its boiling point is as high as 42.5° C., and therefore methyl iodide cannot be used for fumigation of wood parasitic nematodes. However, if methyl iodide is dissolved in liquefied carbon dioxide, methyl iodide can be introduced into a treatment room through spraying and diffusing in form of fine particles by use of high pressure of the liquefied carbon dioxide. The present inventors have found out that the thus introduced fine particles of methyl iodide can evaporate and remove wood parasitic nematodes through fumigation within a short time. Moreover, they have confirmed that by using combination of one or more compounds selected from the group consisting of sulfuryl fluoride, methyl isothiocyanate, phosphine, ethylene oxide, carbonyl sulfide and propylene oxide and methyl iodide dissolved in liquefied carbon dioxide, wood with nematodes parasitic therein can be also efficiently disinfested, to thereby complete the present invention.

That is, the present invention provides the following fumigant for wood parasitic nematodes and wood fumigation method.

1. A fumigant for wood parasitic nematodes, comprising methyl iodide and liquefied carbon dioxide in which methyl iodide is dissolved.
2. The fumigant for wood parasitic nematodes described in 1, wherein the concentration of methyl iodide in the liquefied carbon dioxide is within a range of 20 to 90 mass %.
3. A method for fumigating wood, comprising killing wood parasitic nematodes by using methyl iodide dissolved in liquefied carbon dioxide in combination with one or more compounds selected from the group consisting of sulfuryl fluoride, methyl isothiocyanate, phosphine, ethylene oxide, carbonyl sulfide and propylene oxide.

### BEST MODE FOR CARRYING OUT THE INVENTION

In the present invention, methyl iodide to be used as active ingredient in the fumigant has a boiling point of 42.5° C. as described above, which is high for a fumigant. In this regard, the present inventors investigated solubility of methyl iodide in various kinds of liquefied high-pressure gases. As a result, they confirmed that methyl iodide can be dissolved well in carbon dioxide gas (the pressure inside the container when the gas is in a liquefied state is about 6 MPa), that the dissolved methyl iodide, which can be discharged by the pressure of the liquefied carbon dioxide, is sprayed and diffused in form of particles when discharged to thereby accelerate evaporation of methyl iodide, and therefore that the dissolved methyl iodide can be used in phytosanitary fumigation. Liquefied carbon dioxide gas is advantageous in that the gas, which is inexpensive, inert and stable with little venomousness, can be expected to exhibit only beneficial chemical effects the active ingredients originally have and that the gas, which is nonflammable and has high pressure, can be sprayed to a large space in a large amount.

Methyl iodide is dissolved in liquefied carbon dioxide arbitrarily. In the fumigant for wood parasitic nematodes, the concentration of methyl iodide as active ingredient in the liquefied carbon dioxide can be from 20 to 90 mass %, preferably 30 to 80 mass %, particularly preferably 40 to 60 mass %. The lower the concentration of methyl iodide in the liquefied carbon dioxide (the higher the pressure of the gas), the more particulate methyl iodide is generated. However, if the concentration is too low, a large amount of liquefied carbon dioxide is required for obtaining desired effects, which is inefficient. On the contrary, if the concentration of methyl iodide in the liquefied carbon dioxide exceeds 90 mass %, a sufficient injection pressure cannot be obtained and the size of the particle containing methyl iodide becomes large to thereby decrease evaporation and transpiration effect.

The use amount of the agent containing methyl iodide dissolved in liquefied carbon dioxide, i.e. the amount (evaporation amount) of methyl iodide required for fumigation varies depending on specific treating conditions such as hermetic state of the treating system, the temperature of the treatment region and the treatment time. Generally, in a case where fumigation is carried out under fumigating conditions of hermetic state, the environmental temperature of 10 to 25° C. and the treatment time of 24 to 48 hours, wood parasitic nematodes can be completely exterminated with an amount from 50 to 110 g of chemical agent/m³.

### [Fumigant for Wood Parasitic Nematodes]

The fumigant for wood parasitic nematodes according to the present invention has as active ingredients methyl iodide dissolved in liquefied carbon dioxide or combination of one or more compounds selected from the group consisting of sulfuryl fluoride, MITC, phosphine, ethylene oxide, carbonyl sulfide and propylene oxide with the methyl iodide dissolved in liquefied carbon dioxide.

In case of using combination of one or more compounds selected from the group consisting of sulfuryl fluoride, MITC, phosphine, ethylene oxide, carbonyl sulfide and propylene oxide with methyl iodide dissolved in liquefied carbon dioxide, nematicidal effects on wood parasitic nematodes can be increased (synergetic effect) as compared with a case of using independently each of the compounds of the same amounts.

There is no limitation on modes for carrying out the invention with respect to the combination of methyl iodide dissolved in liquefied carbon dioxide with one or more other effective compounds selected from the group consisting of sulfuryl fluoride, MITC, phosphine, ethylene oxide, carbonyl sulfide and propylene oxide with. Alternatively, methyl iodide dissolved in liquefied carbon dioxide may be sprayed substantially at the same time with each of the other effective compounds.

The ratio of the used amounts between the methyl iodide dissolved in liquefied carbon dioxide and one or more other effective compounds selected from the group consisting of sulfuryl fluoride, MITC, phosphine, ethylene oxide, carbonyl sulfide and propylene oxide serving as active ingredients varies depending on the kind of compounds combined and the kind and condition of wood to be treated with fumigation. Generally, it is from 1 (methyl iodide):0.1 to 0.5 (methyl iodide):1.

[Fumigation Method]

In fumigation method of the present invention, for example, the methyl iodide dissolved in liquefied carbon dioxide may be injected by use of the pressure of the liquefied carbon dioxide to wood in a treatment room where the wood is placed. Alternatively, the methyl iodide dissolved in liquefied carbon dioxide may be appropriately combined with one or more other effective compounds selected from the group consisting of sulfuryl fluoride, MITC, phosphine, ethylene oxide, carbonyl sulfide and propylene oxide and introduced into the treatment room where the wood is placed, to thereby treat the wood.

That is, for example, introduction of the fumigant of the present invention is carried out through evaporation or spraying into the treatment room as described above.

Specifically, the methyl iodide dissolved in liquefied carbon dioxide may be sprayed by use of the pressure of the liquefied carbon dioxide or the methyl iodide dissolved in liquefied carbon dioxide may be sprayed to wood placed in a hermetically-sealed treatment room together with one or more compounds selected from the above compounds serving as the other active ingredients, followed by treating the wood at a predetermined temperature for a predetermined time to thereby kill wood parasitic nematodes.

Since the methyl iodide dissolved in liquefied carbon dioxide can use the pressure of the liquefied carbon dioxide when discharged, the methyl iodide discharged from the container can be sprayed and diffused in form of particles, which facilitates rapid evaporation of the methyl iodide, thereby achieving the aim of phytosanitary fumigation.

The use amount of the fumigant varies depending on the kind and growth stage of the nematode, the kind and amount of the wood, the shape of the treatment room and the temperature. Generally, in case of methyl iodide, the use amount is in a range of 30 to 120 g per 1 m³ treatment room, preferably 50 to 110 g. In case of using combination of methyl iodide and the above described other components serving as active ingredients, the use amount of methyl iodide may be smaller than the amount used in the above general case using methyl iodide only.

Other fumigating conditions may be the same as in conventional methods. For example, the fumigation temperature in a case of using methyl iodide is 5° C. or higher. If the temperature is too low, the amount of the fumigant must be larger and therefore, the preferred temperature is 15° C. or higher. Although the fumigation time may be changed according to the amount of the fumigant and the fumigation temperature, the time length is generally 24 hours.

Examples of fumigation method include tent fumigation, on-board fumigation, barge fumigation and warehouse fumigation.

There is no particular limitation on the area of production, kind and shape of the wood to be fumigated.

Examples of area of production and kind of the wood include lumber (conifer), Russian timber (conifer) and tropical wood (broad leaf tree). Examples of the wood shape include raw wood log and sawed lumber such as square log and board.

A particularly important example of wood parasitic nematodes to be fumigated is Bursaphelenchus xylophilus, which is a typical example. The present invention is not limited to this example.

According to the fumigation method of the present invention, nematodes parasitic under the bark of the wood and inside the wood can be exterminated in a simple manner inexpensively and efficiently.

### EXAMPLES

Hereinafter, the present invention is described in detail with reference to Preparation Examples and Examples, however, these examples are shown to explain the present invention and the invention is by no means limited thereto.

### Preparation Example 1

After 1000 g of methyl iodide was weighed and placed into a high-pressure cylinder, it was filled with liquefied carbon dioxide to thereby dissolve the methyl iodide in the cylinder and thus the fumigant for wood parasitic nematodes, with the concentration of methyl iodide of 50 mass % in liquefied carbon dioxide was prepared.

### Example 1

Red deal parasitized by Bursaphelenchus xylophilus was lumbered to prepare 15 cm square log, 10 cm square log and 2 cm×10 cm board, and each was cut to have a length of 1 m. Each wood was appropriately placed inside a pipe frame, and stacked to form a volume of 1 m³. The pipe frame was covered with a fumigation sheet to form a tent having a volume of 2.0 m³. 160 g/m³ of the methyl iodide fumigant prepared in Preparation Example 1 (80 g/m³ as methyl iodide) was injected by spraying into the tent and fumigation was carried out at 15° C. for 24 hours. The tent was opened after completion of fumigation, and the sample wood was left standing for a week. Detection of nematodes was performed by Bellman method. The wood materials on which more than 10,000 individuals of Bursaphelenchus xylophilus parasitizing were detected before the fumigation treatment were subjected to the detection method. Three samples of each of 15 cm square log materials, 10 cm square log materials and board materials were used and a wood piece of 100 g was cut out of three or more parts per sample wood and the number of nematodes parasitic in each of the pieces was counted. As a result, no living nematodes were found in the wood materials in the fumigation treatment area, showing that 100% of the nematodes had been killed.

### Example 2

The test on the fumigation effect was carried out as the same manner as in Example 1. The conditions were as same as in Example 1 except that the temperature was 10° C. and that the amount of the methyl iodide fumigant prepared in Preparation Example 1 was 192/m³ (the amount of the methyl iodide: 96 g/m³). In addition, an area where methyl iodide as is, not prepared into formulation, was injected through an injection syringe into the tent was prepared as control. As a result, the effect of killing nematodes was only 98% in the control area (the amount of the methyl iodide: 96 g/m³) while 100% of the effect of killing nematodes was obtained in the area where the methyl iodide prepared in the Preparation Example 1 was injected. In phytosanitary disinfection, 100% extermination of insects is required and effectiveness of the present invention was thus verified.

### Example 3

The test on the fumigation effect was carried out as the same manner as in Example 1. The conditions were as same as in Example 1 except that the amount of the methyl iodide fumigant prepared in Preparation Example 1 was 50/m³ (the amount of the methyl iodide: 25 g/m³) and that 25 g/m³ Of sulfuryl fluoride was injected at the same time. In addition, an area where sulfuryl fluoride alone was injected into the tent was prepared as control. As a result, the effect of killing nematodes was only 89% in the control area (the amount of the sulfuryl fluoride: 50 g/m³) while 100% of the effect of killing nematodes was obtained in the area where the methyl iodide prepared in the Preparation Example 1 and sulfuryl fluoride were injected at a time.

### INDUSTRIAL APPLICABILITY

The present invention is to provide a fumigant for wood parasitic nematodes replacing methyl bromide, the use of which is regulated as ozone depleting substance and wood fumigation method, which enables simple and inexpensive disinfection of wood workable anywhere.

Although methyl iodide, having boiling point of 42.5° C. which is high for a fumigant, cannot be used as is in fumigation of wood parasitic nematodes. However, methyl iodide dissolved in liquefied carbon dioxide is introduced into a treatment room, since it can be sprayed and diffused in form of fine particles by use of high-pressure of the liquefied carbon dioxide, 100% of wood parasitic nematodes can be exterminated through evaporation of the fumigant within a short time. Also, by using combination of one or more other effective compounds selected from the group consisting of sulfuryl fluoride, methyl isothiocyanate (herein after sometimes referred to as MITC), phosphine, ethylene oxide, carbonyl sulfide and propylene oxide and methyl iodide dissolved in liquefied carbon dioxide and injecting them substantially at the same time, high effect in fumigating the wood with nematodes parasitic therein can be obtained.

1. A fumigant for wood parasitic nematodes, comprising methyl iodide and liquefied carbon dioxide in which methyl iodide is dissolved.

2. The fumigant for wood parasitic nematodes claimed in claim 1, wherein the concentration of methyl iodide in the liquefied carbon dioxide is within a range of 20 to 90 mass %.

3. A method for fumigating wood, comprising killing wood parasitic nematodes by using methyl iodide dissolved in liquefied carbon dioxide in combination with one or more compounds selected from the group consisting of sulfuryl fluoride, methyl isothiocyanate, phosphine, ethylene oxide, carbonyl sulfide and propylene oxide.
